(19) United States
(12) Patent Application Publication
(10) Pub. No.: US 2026/0283172 A1
(43) Pub. Date: Sep. 24, 2026

(54) MULTI-MODULE THERMAL FOOD PROCESSING SYSTEM AND RELATED METHODS

(71) Applicant: Deaktiv Inc., Maple Valley, WA (US)

(72) Inventor: Kevin Petersen, Maple Valley, WA (US)

(73) Assignee: Deaktiv Inc., Maple Valley, WA (US)

(21) Appl. No.: 19/629,429

(22) Filed: Mar. 26, 2026

Related U.S. Application Data
(63) Continuation-in-part of application No. 19/083,279, filed on Mar. 18, 2025.

(51) Int. Cl. A23B 7/01; A23B 7/005

(52) U.S. Cl. CPC A23B 7/01; A23B 7/0053

(57) ABSTRACT

A multi-module food processing system is provided for the thermal treatment of produce, featuring a unified processing tunnel that incorporates various oven modules. These include microwave oven modules for volumetric heating, combination steam-convection oven modules for applying heated air and steam, and an infrared oven module for surface heating. The system is equipped with a belt conveyor for transporting produce through the tunnel and a computer-control module for monitoring and regulating energy inputs, temperature and humidity levels, and conveyor speed. The method involves spreading produce into a uniform layer, sequentially conveying it through the different modules to achieve desired internal and surface temperatures, and reducing the product layer depth. The coordinated application of volumetric, convective, and surface-directed heating enables rapid pathogen reduction and enzyme deactivation while preserving sensory quality of the produce.

### CROSS-REFERENCE TO RELATED APPLICATIONS

This application is a Continuation-in-Part (CIP) of, and claims priority to, U.S. patent application Ser. No. 19/083,279 filed on Mar. 18, 2025, which claims the benefit of priority to U.S. Provisional Application No. 63/566,975 filed on Mar. 19, 2024. The entire disclosures of these applications are incorporated herein by reference.

### TECHNICAL FIELD

The present invention relates to food processing systems, and more particularly, to multi-modal thermal treatment systems useful for extending the shelf-life of fruits and vegetables. In certain embodiments, the disclosed systems integrate multiple thermal modalities in a coordinated sequence to achieve controlled internal and surface heating profiles for produce.

### BACKGROUND OF THE INVENTION

Food processing technologies have evolved significantly over the years, driven by the need to ensure food safety, extend shelf life, and maintain the nutritional and sensory qualities of food products. Thermal processing is a critical component of food preservation, involving the application of heat to deactivate spoilage enzymes and pathogens. Traditional methods such as pasteurization and sterilization have been widely used, but they often involve high temperatures and long hold/dwell times that can degrade the quality of the food. As consumer demand for fresh-like, minimally processed foods increases, there is a growing interest in developing advanced thermal processing techniques that can achieve microbial safety and enzyme deactivation without compromising food quality.

In the realm of thermal food processing, various technologies have been explored, including microwave heating, steam-convection heating, and infrared heating. Each of these methods offers unique advantages and challenges. Microwave heating is known for its rapid volumetric heating capabilities, which can quickly raise the internal temperature of food products. However, it often results in non-uniform heating and can cause product damage such as bursting or uneven texture. Steam-convection heating provides uniform temperature distribution and maintains moisture levels, but it is generally slower and may not achieve the rapid surface heating required for effective enzyme/pathogen deactivation. Infrared heating, on the other hand, offers intense surface heating, which is effective for surface pasteurization, but it can lead to dehydration and surface quality degradation if not carefully controlled.

The prior art in food processing has largely focused on the use of these heating methods in isolation, each addressing specific aspects of food safety and quality. For instance, microwave heating has been employed for its speed and efficiency, particularly in thawing and initial heating stages. Steam-convection systems have been utilized for their ability to maintain product moisture and achieve uniform heating, while infrared systems have been applied for surface treatments to achieve rapid pathogen reduction. However, these methods, when used independently, have inherent limitations that can affect the overall effectiveness and quality of the processed food.

Therefore, there is a clear and unmet need in the field of food processing for a system that can integrate these distinct heating technologies into a cohesive process. Such a system would ideally leverage the strengths of each method while mitigating their individual drawbacks, achieving a comprehensive thermal treatment that ensures food safety and quality. The development of a multi-modal system that combines microwave, steam-convection, and infrared heating in a sequential manner represents a significant advancement in the field, offering a solution that can uniformly deactivate enzymes and pathogens while preserving the sensory attributes of the food.

While combinations of heating technologies have been proposed, prior systems fail to coordinate volumetric heating, humidity-controlled convection heating, and surface-directed infrared heating in a manner that decouples internal and surface thermal objectives. As a result, prior approaches are unable to simultaneously achieve rapid pathogen reduction, enzyme deactivation, and preservation of sensory quality without overprocessing or product damage.

### BRIEF SUMMARY OF THE INVENTION

The multi-module food processing system (and related methods) described herein possess several aspects, no single one of which is solely responsible for its desirable attributes. Without limiting the scope of the appended claims, certain features of the disclosure will be briefly discussed. A fuller understanding of how these features provide significant advantages will be gained after reading the ‘Detailed Description’section that follows.

The present invention, in a first aspect, is directed to a multi-module food processing system configured for thermally treating selected produce (i.e., minimally processed fruits and vegetables). The system includes a unified processing tunnel configured to receive and process produce therethrough. The system consists of several distinct modules, integrated together in series, including: (1) a first microwave oven module that raises the internal average temperature of the selected fruit or vegetable up to the thaw point by applying a first amount of microwave energy; (2) a first combination steam-convection oven module that maintains a first relative humidity and raises the internal average temperature of the selected fruit or vegetable up to a first temperature by applying a first amount of heated air and steam; (3) a second microwave oven module that raises the internal average temperature of the selected fruit or vegetable up to a second temperature by applying a second amount of microwave energy; (4) a second combination steam-convection oven module that maintains a third relative humidity and maintains or raises the internal temperature of the selected fruit or vegetable up to a third temperature by applying a second amount of heated air and steam; and (5) an infrared oven module that maintains a fourth relative humidity and maintains or raises the internal temperature of the selected fruit or vegetable up to a fourth temperature by applying a first amount of infrared energy.

In certain embodiments, the modules are arranged and operated such that volumetric heating provided by one or more microwave modules raises an internal temperature of the produce prior to surface-directed heating, while subsequent humidity-controlled convection stages promote uniform temperature distribution and moisture retention. A downstream infrared module is configured to selectively elevate a surface temperature of the produce after reduction of a product layer depth, thereby enabling rapid surface lethality without prolonged exposure that would otherwise degrade internal structure.

The produce is transported through the unified processing tunnel and processed through each of the modules in sequence and, preferably, by way of a belt conveyor. The system is controlled by a computer-control module configured to monitor and regulate energy inputs to each module, temperature and humidity levels, and a speed of the belt conveyor system. In certain embodiments, the computer-control module implements closed-loop control based on one or more sensed parameters, including temperature, moisture, or dielectric properties of the produce, and dynamically adjusts process parameters to achieve a target thermal profile. The system is designed to provide a multi-modal thermal treatment of produce, deactivating enzymes and killing pathogens, thereby ensuring food safety and quality (and extending food shelf-life). The use of different modules allows for the treatment of produce at various stages of processing, from fresh or frozen to final product, and can be tailored to specific types of produce and desired outcomes.

Certain other aspects of the present invention provide a method for thermally treating produce to deactivate enzymes and pathogens while preserving sensory quality. The method generally includes (i) spreading produce into a product layer of uniform depth on a belt conveyor, (ii) conveying the produce through a first microwave oven module and applying a first amount of microwave energy to the produce to volumetrically heat the produce and raise an internal temperature of the produce, (iii) conveying the produce through a first combination steam-convection oven module and applying heated air and steam to the produce to raise the surface and internal temperatures while maintaining a first relative humidity, (iv) conveying the produce through a second microwave oven module and applying a second amount of microwave energy to the produce, (v) conveying the produce through a second combination steam-convection oven module and applying heated air and steam to the produce, (vi) reducing the depth of the product layer, and (vii) conveying the produce through an infrared oven module and applying infrared energy to a surface of the produce to raise a surface temperature while maintaining a controlled relative humidity.

The foregoing summary, as well as the following detailed description, is not intended to be exhaustive or to limit the disclosure to the precise forms disclosed. The features described are indicative of but a few of the various ways in which the principles of the disclosure may be employed. The present invention is intended to include all such aspects and their legal equivalents, with the full scope being defined by the appended claims.

These and other aspects of the present invention will become more readily apparent to those of ordinary skill in the art when reference is made to the following detailed description in view of the accompanying drawing.

### BRIEF DESCRIPTION OF THE DRAWINGS

The accompanying drawings illustrate certain preferred embodiments and related aspects of the present invention and, together with the detailed description, serve to explain how to practice the invention from the perspective of a person of ordinary skill in the art.

FIG. 1 shows a high-level symbolic schematic plan view of a multi-module food processing system in accordance with an embodiment of the present invention.

FIG. 2 is a flow chart that illustrates a series of process steps for deactivating enzymes and destroying pathogens in accordance with another embodiment of the present invention.

### DETAILED DESCRIPTION OF THE INVENTION

In the following description, certain specific details are set forth in order to provide a thorough understanding of various embodiments of the disclosure. However, one skilled in the art will understand that the disclosure may be practiced without these details. In other instances, well-known structures and functions have not been shown or described in detail to avoid unnecessarily obscuring the description of the embodiments of the invention.

Unless the context requires otherwise, throughout the specification, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Unless defined otherwise, all technical and scientific terms used herein have the same meaning as commonly understood by one of ordinary skill in the art to which this disclosure pertains.

As used herein, the term “produce” refers to raw fruits and vegetables, including but not limited to whole, sliced, diced, or otherwise particulated forms. Non-limiting examples include blueberries, apples, cherries, bell peppers, potatoes, apricots, avocados, bananas, beans, berries, cauliflower, corn kernels, eggplants, grapes, mangoes, melons, mushrooms, peaches, and pears.

As used herein, “thermally treating” or “thermal treatment” refers to the application of heat to produce to achieve a desired biological or chemical change, such as enzyme deactivation or pathogen reduction.

As used herein, a “unified processing tunnel” refers to a single, continuous enclosure or housing (optionally with removable protective shrouds) that contains multiple, distinct processing modules arranged in a sequential, in-line configuration.

As used herein, a “microwave oven module” refers to a component of the system that generates and applies microwave energy to the produce. Its primary function is to cause “volumetric heating.”

As used herein, a “combination steam-convection oven module” refers to a component of the system that applies heat to the produce using a combination of forced hot air (convection) and the injection of steam. Its primary functions are to ensure uniform temperature distribution and to control the relative humidity within the module, thereby preventing dehydration of the produce.

As used herein, an “infrared oven module” refers to a component of the system that generates and applies infrared radiation to the produce. Its primary function is to cause rapid “surface heating.”

As used herein, “volumetric heating” refers to a heating mechanism, characteristic of microwave energy, where heat is generated internally within the body of the produce due to the interaction of electromagnetic waves with polar molecules (e.g., water). This results in a rapid increase in the internal temperature of the produce.

As used herein, “surface heating” refers to a heating mechanism, characteristic of infrared energy, where heat is primarily absorbed at the surface of the produce and then conducted inwards. This results in a rapid increase in the surface temperature of the produce.

As used herein, “downstream” refers to the direction of travel of the produce on the belt conveyor system. A module that is “downstream” of another module is encountered later in the processing sequence.

As used herein, a “product layer” refers to the arrangement of produce on the belt conveyor, typically spread to a specified depth and uniformity.

As used herein, “sensory quality” refers to the organoleptic properties of the produce that are perceived by the senses, including but not limited to texture (e.g., firmness, crispness), flavor, aroma, and appearance (e.g., color, shape, lack of wrinkling or browning).

As used herein, “enzyme deactivation” refers to the process of reducing or eliminating the activity of endogenous enzymes in the produce, such as polyphenol oxidase (PPO), which is responsible for enzymatic browning. The goal is to preserve the quality and extend the shelf-life of the produce.

As used herein, “pathogen reduction” refers to the process of inactivating or killing pathogenic microorganisms, such as bacteria (e.g., “Listeria monocytogenes”), yeasts, spores, and molds, to improve the safety of the food product. This is often quantified as a logarithmic (log) reduction in the number of viable microorganisms.

As used herein, “residence time” (sometimes referred to as “dwell time”) refers to the duration, or amount of time, a piece or produce spends within one of the modules.

As used herein, the term “thermal profile” refers to a time-varying combination of temperature, humidity, and energy input experienced by produce as it traverses the processing system.

As used herein, the term “layer reduction” refers to a controlled decrease in the thickness of a product layer to increase surface area exposure and improve uniformity of subsequent thermal treatment.

In view the foregoing, the present invention is directed to systems and methods for the thermal treatment of produce. A challenge in the food processing industry is the deactivation of spoilage enzymes and harmful pathogens in raw fruits and vegetables without concurrently degrading the product's sensory quality. Conventional thermal processing methods often present a trade-off between safety/shelf-life and quality. For instance, heating methods that rely solely on surface heat transfer (e.g., convection or infrared) can be slow, requiring long processing times that “cook” the product, leading to loss of texture, flavor, and color. Conversely, methods relying solely on volumetric heating (e.g., microwave) can cause non-uniform heating, localized overheating, and product damage such as bursting or textural breakdown, particularly in products with irregular shapes and sizes.

The presently disclosed systems and methods overcome these limitations by providing a multi-modal thermal processing system that synergistically combines different heating technologies in a specific, sequential arrangement. A core aspect of the disclosed technology is the strategic application of volumetric heating to rapidly raise the internal temperature of the produce, followed by uniform heating in a controlled-humidity environment, and culminating in a rapid surface heating step. This sequence achieves a thorough and rapid thermal treatment that deactivates enzymes and pathogens throughout the product, from core to surface, while minimizing the total heat exposure time and preserving the delicate sensory qualities of the produce.

The system architecture is designed to execute this synergistic process. An initial microwave oven module performs rapid volumetric heating, efficiently raising the core temperature of the produce, which is particularly effective for bringing frozen produce to its thaw point without damaging the surface. This overcomes the primary bottleneck of slow heat conduction inherent in surface-only heating methods. Following this, one or more combination steam-convection oven modules provide uniform heating and maintain a high-humidity environment. This prevents moisture loss and surface dehydration, which would otherwise lead to wrinkling and a degraded appearance. After the internal temperature is sufficiently raised, a final infrared oven module delivers a short, intense burst of energy to the product's surface. This final step elevates the surface temperature to a target lethal for pathogens and sufficient for deactivating surface enzymes, without requiring prolonged heating that would damage the product's internal structure and texture. By decoupling the tasks of core heating and surface heating and executing them with the most efficient modality for each, the overall process is faster, more effective, and gentler on the product than any single-modality system.

In certain embodiments, the system achieves the described thermal treatment while maintaining industrial throughput rates, thereby avoiding trade-offs between processing speed and product quality.

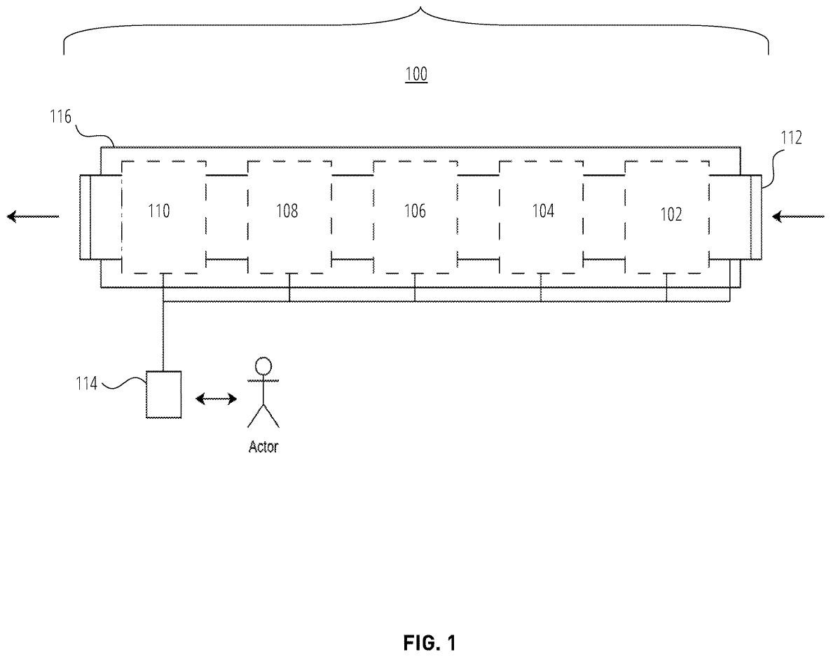

Referring now to the drawings, FIG. 1 illustrates a high-level symbolic schematic plan view of a multi-module thermal processing system 100 accordance with an embodiment of the present invention. In simplest form, the multi-module thermal processing system 100 comprises, in series, (1) a first microwave oven module 102, (2) a first steam-convection oven module 104, (3) a second microwave oven module 106, (4) a second steam-convection module 108, and (5) an infrared oven module 110. A belt conveyor system 112 is provided to transport the product (not shown) through the multi-module thermal processing system 100 by way of an interconnecting unified processing tunnel 116. Additionally, a computer-control module 114 is provided for process control. In certain embodiments, the system may be configured for batch or semi-continuous processing.

In certain embodiments, the modules are configured to perform distinct thermal functions. The microwave oven modules 102, 106 provide volumetric heating to raise internal temperature of the produce. The steam-convection oven modules 104, 108 provide humidity-controlled convective heating to promote uniform temperature distribution and prevent dehydration. The infrared oven module 110 provides surface-directed heating to rapidly elevate surface temperature for pathogen reduction and enzyme deactivation. The sequential arrangement enables decoupling of internal temperature elevation from surface temperature elevation, allowing independent optimization of each.

As shown, a first microwave oven module 102 is located at the beginning part of the multi-module food processing system 100. This module is configured to apply microwave energy to the produce for initial volumetric heating, raising the internal temperature from a frozen state to a thaw point. The first microwave oven module 102 is configured to operate at a power of approximately 25 kW and a frequency of approximately 915 MHz, which facilitates the efficient transfer of energy to the produce. The first microwave oven module 102 is part of a unified processing tunnel 116, where produce is transported by a belt conveyor system 112. This system ensures that the produce moves sequentially through each module, including the first microwave oven module 102, at a controlled speed. In certain embodiments, the microwave oven module operates in conjunction with one or more sensors configured to detect temperature or dielectric properties of the produce, enabling adaptive control of microwave energy delivery to reduce non-uniform heating.

Depending on need, the belt conveyor system 112 may be configured in an embodiment to transport the produce at a throughput rate of approximately 500 to 800 kg per hour (or about 110 to 175 pounds per hour), thereby optimizing the processing efficiency. In another embodiment, the belt conveyor system 112 may be configured to transport the produce at a throughput rate of approximately 900 kg per hour (or about 2,000 pounds per hour), thereby optimizing the processing efficiency. In certain preferred embodiments, the belt conveyor system 112 comprises a series of discrete conveyor belt sub-systems (not shown) arranged in series whereby each conveyor belt sub-system corresponds to, and is partially contained within, one of the modules of the multi-module thermal processing system 100. In this configuration, produce is conveyed in a continuous sequence through each module, with gravity-fed flow from a primary conveyor belt sub-system located upstream and a secondary conveyor belt sub-system located downstream.

A computer-control module 114 monitors and regulates the energy inputs to the first microwave oven module 102, as well as the speed of the belt conveyor system 112. This regulation is for optimizing the process for specific types of produce, such as blueberries, sliced apples, or shredded potatoes, ensuring that the desired internal temperature is achieved without compromising the sensory quality of the produce. The first microwave oven module 102 works in conjunction with other modules in the system 100, such as the combination steam-convection oven modules 104, 108, the second microwave oven module 106, and the infrared oven module 110 to provide a comprehensive thermal treatment. This multi-modal approach deactivates enzymes and pathogens while preserving the sensory quality of the produce.

Downstream from the first microwave oven module 102 is the first combination steam-convection oven module 104. The first combination steam-convection oven module 104 applies heated air and steam to the produce to achieve uniform temperature elevation. This module is configured to maintain a relative humidity (preferably below approximately 60%) to reduce surface moisture accumulation while limiting dehydration, thereby promoting uniform heating without case hardening or surface degradation. The application of heated air and steam ensures that the temperature rise is consistent throughout the product bed.

Downstream from the first combination steam-convection oven module 104 is the second microwave oven module 106. The second microwave oven module 106 applies further microwave energy for volumetric heating to the produce. This module is configured to raise the internal temperature of the produce, contributing to the deactivation of enzymes and pathogens while preserving sensory quality. The second microwave oven module 106 also works in conjunction with other modules. In certain preferred embodiments, the first and second microwave oven modules 102, 106 each operate at a power of approximately 25 kW to 100 kW and at a frequency of approximately 902 MHz to 928 MHz.

Downstream from the second microwave oven module 106 is the second combination steam-convection oven module 108. The second combination steam-convection oven module 108 applies heated air and steam to the produce, resulting in a uniform temperature elevation within a humid environment. The application of heated air and steam maintains the desired relative humidity (preferably greater than 60%), which can prevent dehydration of the produce during the thermal treatment process. The second combination steam-convection oven module 108 may include a layer reduction mechanism configured to reduce a depth of the product layer prior to downstream processing. In certain embodiments, the layer reduction mechanism comprises a vibratory conveyor, transfer belt, or redistribution system configured to increase exposed surface area and improve uniformity of subsequent infrared heating. Reduction of the product layer depth prior to infrared heating enables more uniform exposure of produce surfaces to infrared energy, thereby reducing processing time required to achieve a target surface temperature and minimizing overheating of interior portions of the produce.

Downstream from the second combination steam-convection oven module 108 is the infrared oven module 110. The infrared oven module 110 applies infrared energy to the surface of the produce for surface heating. This module is configured to provide rapid surface heating, thereby achieving a final target temperature necessary for pathogen and enzyme deactivation. The infrared energy is applied by way of infrared emitters (not shown) and operates at a power level selected based on system throughput and product characteristics, which may range from approximately 35 kW to 180 kW in various embodiments.

The computer-control module 114 monitors and regulates the energy inputs to each module, the temperature and humidity levels, and the speed of the belt conveyor system 112 within the multi-module food processing system 100 (which speed, in turn, determines the residence time of the produce within each module). This module optimizes the process for specific types of produce, ensuring that each module operates under the correct conditions to achieve the desired thermal treatment (sometime referred to as “thermal profile”). The computer-control module 114 is configured to adjust parameters dynamically, allowing for real-time modifications based on the produce being processed. This capability maintains the balance between deactivating enzymes and pathogens and preserving the sensory quality of the produce. The module also ensures that the belt conveyor system 112 transports the produce through the unified processing tunnel 116 at a controlled speed (thereby ensuring that residence time the produce spends within each module is between 10 and 120 seconds, and more preferably between 30 and 90 seconds). By regulating these parameters, the control module 114 facilitates a continuous thermal treatment process that is both efficient and adaptable to various types of produce. In certain embodiments, the control module 114 is configured to execute predefined or adaptive thermal profiles tailored to specific types of produce, and to dynamically adjust conveyor speed, energy inputs, and humidity levels in response to real-time measurements. In certain embodiments, the control module 114 operates in a feed-forward mode using predefined parameters, or in a feedback mode.

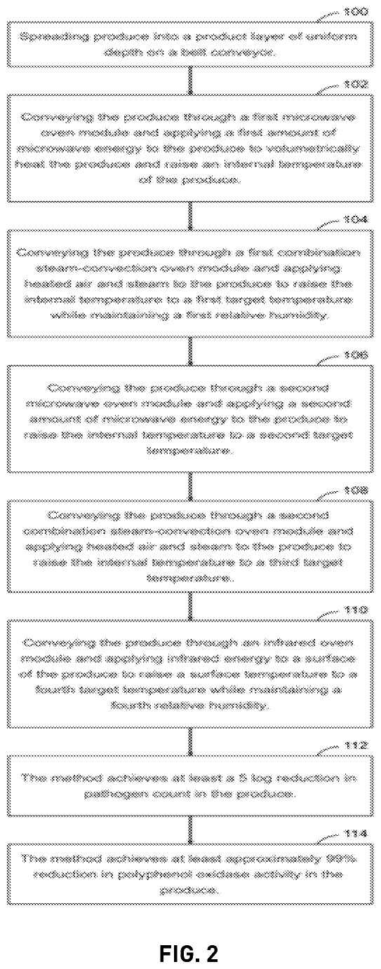

FIG. 2 is a flowchart illustrating a method for thermally treating produce. In certain embodiments, the method is configured such that volumetric heating steps precede surface-directed heating steps, and layer reduction is performed prior to infrared heating to enhance surface exposure. At step 100, the produce may be spread into a product layer of uniform depth on a belt conveyor. This operation may be facilitated by the multi-module food processing system, which may include a unified processing tunnel. The spreading of produce into a uniform layer is for ensuring consistent thermal treatment as the produce progresses through the subsequent modules. The belt conveyor system may be configured to transport the produce through the unified processing tunnel, ensuring that each piece of produce is exposed to the same conditions. This uniformity in the product layer is for achieving the desired thermal effects, such as deactivating enzymes and pathogens while preserving the sensory quality of the produce.

In step 102, the produce is conveyed through the first microwave oven module, where a first amount of microwave energy is applied to volumetrically heat the produce. This process raises the internal temperature of the produce, potentially transitioning it from a frozen state to a thaw point. The first microwave oven module's role in raising the internal temperature of the produce is for the subsequent stages of the thermal treatment process, which includes additional heating and humidity control to achieve the desired level of enzyme and pathogen deactivation.

In step 104, the produce is conveyed through a first combination steam-convection oven module. This module is configured to apply heated air and steam to the produce, which raises the internal temperature to a first target temperature. The process is designed to maintain a first relative humidity, potentially below approximately 60%.

In step 106, the produce is conveyed through a second microwave oven module, where a second amount of microwave energy is applied to raise the internal temperature of the produce to a second target temperature.

In step 108, the produce is conveyed through a second combination steam-convection oven module. This module applies heated air and steam to the produce, potentially raising the internal temperature to a third target temperature. The process also involves the reduction of the product layer depth by a factor of approximately 1.5 to 10 times. The second combination steam-convection oven module is configured to apply heated air and steam to the produce while maintaining a relative humidity, which may contribute to uniform temperature elevation in a humid environment.

In step 110, the produce is conveyed through an infrared oven module, where infrared energy is applied to the surface of the produce. This process selectively raises the surface temperature of the produce to a target level sufficient for pathogen reduction while limiting additional heating of the interior of the produce. The infrared oven module is configured to maintain a fourth relative humidity above approximately 60%, which is for achieving the desired surface heating without causing dehydration. The application of infrared energy provides rapid surface heating, which is for achieving the final target temperature necessary for the deactivation of surface enzymes and pathogens.

The method may achieve a reduction in pathogen count within the produce, potentially reaching at least a 5-log reduction.

The method may achieve a reduction in polyphenol oxidase activity within the produce, potentially reaching approximately 99%.

In various embodiments, one or more parameters including product layer depth, residence time, temperature, humidity, and energy input are selected to achieve at least a target pathogen reduction level and/or enzyme deactivation threshold while preserving sensory quality.

### EXAMPLES

The following examples are provided for illustrative purposes and, unless otherwise indicated, are prophetic in nature and describe expected results based on the disclosed systems and methods.

### Example 1: Deactivation of Enzymes in Blueberries

An apparatus as described herein may be configured for the continuous treatment of frozen blueberries. A stream of blueberries may be fed at a rate of 500 kg/hour onto a first conveyor belt, forming a first monolayer with a controlled average depth of 25 mm. The first conveyor may transport this monolayer through a 25 kW, 915 MHz microwave heating system over a residence time of 75 seconds. The relative humidity within the microwave chamber may be maintained at 40% RH using a dry air circulation system. Upon exiting the microwave system, the blueberries may be measured to have an average core temperature of 160° F.

The heated blueberries may then be discharged into a vibratory transition zone, which may spread the berries onto a second, wider conveyor belt over a period of 30 seconds. The resulting second monolayer may have an average depth of approximately 2.5 mm, representing a 10-fold reduction in depth. The second conveyor transports this thin monolayer through a 35 kW infrared heating system equipped with steam injectors. The residence time in the infrared system may be 50 seconds, and the relative humidity may be maintained at 90% RH. The blueberries exiting the infrared system may have an average surface temperature of 185° F.

The processed blueberries may be subsequently cooled and packaged. A sample may be analyzed for polyphenol oxidase (PPO) activity, which is expected to reveal a 99% reduction compared to an untreated control sample. A sample may be analyzed and is expected to achieve a 5-log reduction of the pathogen germ count. Visual inspection is expected to show the berries retained their shape, color, and turgor, with sensory panel tests confirming no discernible loss of texture or flavor.

### Example 2: Treatment of Sliced Apples to Prevent Browning

Freshly sliced apples (Granny Smith variety, 5 mm thickness) may be processed to prevent enzymatic browning. The apple slices may be fed onto the first conveyor to form a first monolayer with an average depth of 30 mm. The conveyor may move the slices through the microwave heating system over a period of 90 seconds. The relative humidity may be maintained at 50% RH, and the slices may reach a first average temperature of 140° F.

The slices may then be dispersed in a heated transition zone onto the second conveyor, forming a second monolayer with an average depth of 6 mm (a 5-fold reduction). The second monolayer may be conveyed through the infrared heating system for 60 seconds. The relative humidity in the infrared chamber may be maintained at 80% RH via steam injection, and the slices may reach a second average temperature of 175° F.

The treated apple slices may be cooled and exposed to ambient air for 24 hours alongside an untreated control group. The treated slices are expected to exhibit no significant browning and achieve a 5-log reduction of the pathogen germ count, while the control group is expected to turn dark brown within two hours. The texture of the treated slices is expected to remain crisp.

### Example 3: High-Throughput Processing of Cherries

A high-throughput process may be simulated for sweet cherries. A continuous stream of 800 kg/hour of pitted cherries may be fed to form a first monolayer of 20 mm depth. The residence time in the microwave heating system may be reduced to 45 seconds, which may achieve a first average temperature of approximately 165° F. at approximately 45% RH. The cherries may be dispersed into a 2 mm thin second monolayer in under 20 seconds. The residence time in the high-humidity (85% RH) infrared system may be 40 seconds, which may reach a final average temperature of approximately 180° F. The process may demonstrate the system's capability for rapid, effective treatment suitable for high-volume production lines, resulting in cherries with deactivated spoilage enzymes, a 5-log reduction in pathogen germ count and preserved firmness.

### Example 4: Treatment of Diced Bell Peppers

To demonstrate applicability to vegetables, diced green bell peppers may be processed. A first monolayer with an average depth of 40 mm may be conveyed through the microwave system for 80 seconds at 55% RH, and may reach a first average temperature of 155° F. The diced peppers may then be dispersed into a second monolayer with an average depth of 5 mm and passed through the infrared system for 70 seconds at 75% RH, which may reach a final average temperature of approximately 170° F. The resulting product is expected to show significantly reduced enzymatic activity, which would lead to a longer shelf life in refrigerated storage, a 5-log reduction in pathogen germ count while retaining the characteristic crunch and color of fresh peppers.

In certain comparative implementations, omission of the layer reduction step prior to infrared heating would be expected to result in non-uniform surface heating and increased processing times required to achieve target surface temperatures, leading to degradation of product texture and quality.

### Example 5: Comparative Example

Two control batches of blueberries from the same lot as Example 1 may be processed for comparison.

Control Batch A may be processed using only the infrared heating system of Example 1. The blueberries may be arranged in a thin 2.5 mm monolayer and passed through the infrared system for 90 seconds at 85% RH to achieve a core temperature of 180° F. The resulting product is expected to exhibit significant surface wrinkling and a dehydrated, leathery texture due to the prolonged, intense surface heating required to heat the core.

Control Batch B may be processed using only the microwave heating system of Example 1. The blueberries may be arranged in a 25 mm thick monolayer and heated for 120 seconds to ensure the surface temperature reaches 180° F. While internal enzyme deactivation may be achieved, the product may suffer from non-uniform heating, with some berries bursting from internal steam pressure while others remain under-processed at the surface.

The results from these comparative examples illustrate the advantages of the two-stage method, which achieves comprehensive and uniform deactivation of enzymes and pathogens without the quality degradation observed when using either heating method in isolation.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. A method for thermally treating produce, the method comprising:
spreading produce into a product layer on a conveyor;
conveying the produce through a first microwave oven module and applying microwave energy to perform volumetric heating to raise an internal temperature of the produce;
conveying the produce through a first steam-convection oven module and applying heated air and steam to promote uniform temperature distribution while maintaining a first controlled humidity;
conveying the produce through a second microwave oven module and applying microwave energy to further raise the internal temperature of the produce;
conveying the produce through a second steam-convection oven module and applying heated air and steam while reducing a depth of the product layer to increase exposed surface area; and
conveying the produce through an infrared oven module and applying infrared energy to selectively raise a surface temperature of the produce to a target level sufficient for pathogen reduction while limiting additional heating of an interior of the produce,
wherein volumetric heating of the produce precedes surface-directed heating, and
wherein reducing the depth of the product layer prior to applying infrared energy improves uniformity of the surface heating by enabling more uniform exposure of produce surfaces to infrared energy.

2. The method of claim 1, wherein the product layer is reduced in depth by a factor between approximately 1.5 and 10 prior to applying infrared energy.

3. The method of claim 1, wherein the first steam-convection oven module maintains a relative humidity below approximately 60% and the second steam-convection oven module maintains a relative humidity above approximately 60%.

4. The method of claim 1, wherein the infrared energy raises the surface temperature of the produce to at least approximately 170° F.

5. The method of claim 1, wherein the microwave energy is applied at a frequency between approximately 902 MHz and 928 MHz.

6. The method of claim 1, wherein reducing the depth of the product layer comprises redistributing the produce using a vibratory conveyor or transfer mechanism.

7. The method of claim 1, further comprising controlling one or more of microwave energy input, convective heating conditions, infrared energy input, or conveyor speed to achieve a target thermal profile.

8. The method of claim 7, wherein controlling comprises monitoring at least one of temperature, moisture, or dielectric properties of the produce.

9. The method of claim 1, wherein the method achieves at least a 5-log reduction in pathogen count in the produce.

10. The method of claim 1, wherein the method achieves at least approximately 99% reduction in polyphenol oxidase activity in the produce.

11. A multi-module food processing system for thermally treating produce, the system comprising:
a plurality of thermal processing modules including:
a first microwave oven module;
a first steam-convection oven module disposed downstream of the first microwave oven module;
a second microwave oven module disposed downstream of the first steam-convection oven module;
a second steam-convection oven module disposed downstream of the second microwave oven module; and
an infrared oven module disposed downstream of the second steam-convection oven module;
a conveyor system configured to transport produce through the plurality of thermal processing modules in sequence; and
a control module configured to monitor and regulate operation of the plurality of thermal processing modules;
wherein the first and second microwave oven modules are configured to raise an internal temperature of the produce prior to surface-directed heating by the infrared oven module, and
wherein the second steam-convection oven module is configured to reduce a depth of a product layer prior to infrared heating to increase surface exposure.

12. The system of claim 11, wherein the second steam-convection oven module comprises a layer reduction mechanism including a vibratory conveyor, transfer belt, or redistribution system.

13. The system of claim 11, wherein the first steam-convection oven module maintains a relative humidity below approximately 60% and the second steam-convection oven module maintains a relative humidity above approximately 60%.

14. The system of claim 11, wherein the infrared oven module is configured to raise a surface temperature of the produce to at least approximately 170° F.

15. The system of claim 11, wherein the microwave oven modules operate at a frequency between approximately 902 MHz and 928 MHz.

16. A thermal processing system for treating produce, comprising:
a plurality of thermal processing modules including at least one microwave heating module, at least one steam-convection heating module, and at least one infrared heating module arranged to process produce;
a conveyor system configured to transport the produce through the plurality of thermal processing modules; and
a control module configured to:
monitor one or more parameters of the produce or a processing environment, including at least one of temperature, moisture, or dielectric properties; and
dynamically adjust one or more of microwave energy input, convective heating conditions, infrared energy input, or conveyor speed to achieve a target thermal profile,
wherein the control module is configured such that internal temperature elevation of the produce is performed prior to surface-directed heating to thereby decouple internal temperature elevation from surface temperature elevation.

17. The system of claim 16, wherein the control module implements closed-loop control based on feedback from one or more sensors.

18. The system of claim 16, wherein the control module is configured to execute predefined thermal profiles corresponding to different types of produce.

19. The system of claim 16, wherein the control module is configured to dynamically adjust conveyor speed to control residence time within one or more modules.

20. The system of claim 16, wherein the control module is configured to control operation of the plurality of thermal processing modules to decouple internal temperature elevation from surface temperature elevation.
